(19) United States
(12) Patent Application Publication
(10) Pub. No.: US 2026/0030372 A1
(43) Pub. Date: Jan. 29, 2026

(54) STORAGE MEDIUM CAPABLE OF ENHANCING SECURITY RELATED TO PRINTING, METHOD OF CONTROLLING INFORMATION PROCESSING APPARATUS, AND INFORMATION PROCESSING APPARATUS

(71) Applicant: CANON KABUSHIKI KAISHA, Tokyo (JP)

(72) Inventor: TAKANOBU SUZUKI, Kanagawa (JP)

(21) Appl. No.: 19/277,110

(22) Filed: Jul. 22, 2025

(30) Foreign Application Priority Data
Jul. 25, 2024 (JP) 2024-119508

(51) Int. Cl. G06F 21/60; G06F 3/12

(52) U.S. Cl. CPC G06F 21/608; G06F 3/1205; G06F 3/1228

(57) ABSTRACT

A non-transitory computer-readable storage medium storing one or more programs installed in an information processing apparatus that includes an OS having a mode for enhancing security related to printing. The one or more programs include instructions, which when executed by one or more processors of the information processing apparatus, cause the information processing apparatus to determine whether or not the mode has been enabled, and display, in a case where it is not determined that the mode has been enabled, a message for prompting a user to enable the mode on a display section of the information processing apparatus.

### BACKGROUND

### Field of the Technology

The present disclosure relates to a storage medium that is capable of enhancing security related to printing, a method of controlling an information processing apparatus, and an information processing apparatus.

### Description of the Related Art

There is known a technique in which a host terminal, such as a PC, instructs a printing apparatus connected to this host terminal to execute print processing by using a printer driver installed as software for controlling the printing apparatus. In the host terminal, an operating system (OS) as basic software has been installed, and the printer driver is configured according to specifications defined by the OS and operates when called by the OS. A maker that provides a printing apparatus can provide, by providing a printer driver adapted to the specifications of the OS, means for instructing the printing apparatus to execute print processing by using the OS.

Incidentally, in Windows (registered trademark), development of an OS having a mode for enhancing security related to printing (Windows Protected Print Mode (hereinafter referred to as the “WPP”)) is under study. When the WPP is enabled, the host terminal becomes incapable of using a printer driver provided by a maker of a printing apparatus, and hence instructs a printing apparatus connected to the host terminal to execute print processing by using general-purpose print software included in the OS in advance. The general-purpose print software is a general-purpose class driver which can be commonly used for printing apparatuses of a plurality of makers (see e.g. Japanese Patent Application Laid-Open No. 2020-87062). By using the WPP, even when a printing apparatus of any maker is connected, the host terminal can instruct the connected printing apparatus to execute print processing while enhancing the security related to printing.

However, in a configuration in which a user performs the setting of the above-mentioned WPP, there is a concern that a user forgets to perform the setting, and as a result, it is impossible to enhance the security related to printing.

### SUMMARY

Embodiments of the present disclosure are directed to providing a mechanism that is capable of preventing a user from forgetting to set a mode for enhancing security related to printing.

According to some embodiments of the present disclosure, there is provided a non-transitory computer-readable storage medium storing one or more programs installed in an information processing apparatus that includes an OS having a mode for enhancing security related to printing, wherein the one or more programs include instructions, which when executed by one or more processors of the information processing apparatus, cause the information processing apparatus to determine whether or not the mode has been enabled, and display, in a case where it is determined that the mode has not been enabled, a message for prompting a user to enable the mode on a display section of the information processing apparatus.

According to some embodiments of the present disclosure, there is provided, there is provided a method of controlling an information processing apparatus including an OS having a mode for enhancing security related to printing, the method comprising: determining whether or not the mode has been enabled; and displaying, in a case where it is determined that the mode has not been enabled, a message for prompting a user to enable the mode on a display section of the information processing apparatus.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a network configuration of a host terminal as an information processing apparatus according to an embodiment of the present disclosure.

FIG. 2 is a schematic view showing an example of an image forming apparatus appearing in FIG. 1.

FIG. 3 is a schematic view showing an example of an internal structure of the image forming apparatus appearing in FIG. 1.

FIG. 4 is a block diagram schematically showing a hardware configuration of the host terminal appearing in FIG. 1.

FIG. 5 is a block diagram schematically showing a software configuration of the host terminal appearing in FIG. 1.

FIG. 6 is a flowchart of a control process performed by the host terminal appearing in FIG. 1.

FIG. 7 is a diagram showing an example of a guide message screen displayed on a display reception input section appearing in FIG. 4.

FIG. 8 is a flowchart showing a variation of the control process performed by the host terminal appearing in FIG. 1.

FIG. 9 is a diagram showing another example of the guide message screen displayed on the display reception input section appearing in FIG. 4.

### DESCRIPTION OF THE EMBODIMENTS

The present disclosure will now be described in detail below with reference to the accompanying drawings showing embodiments thereof. The relative arrangement of components, an apparatus shape, and so forth of an apparatus used in this embodiment are shown by way of example and are not limited to these. Further, in the accompanying drawings, identical or similar components are denoted by the same reference numerals, and redundant description thereof is omitted.

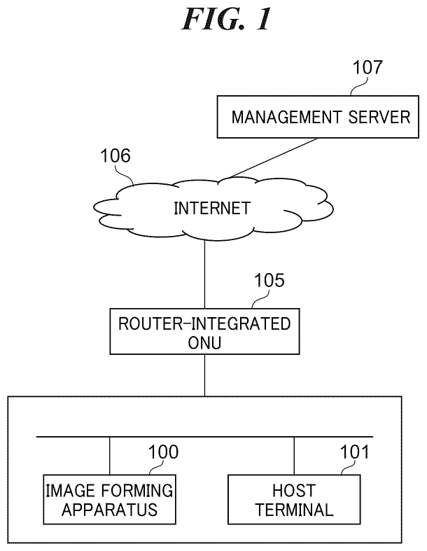

FIG. 1 is a diagram showing an example of a network configuration of a host terminal 101 as an information processing apparatus according to an embodiment of the present disclosure.

As shown in FIG. 1, the host terminal 101 is communicably connected to an image forming apparatus 100. For example, the host terminal 101 transmits print job data including information necessary for execution of print processing to the image forming apparatus 100 according to an instruction received from a user. Further, the host terminal 101 is communicably connected to the Internet 106 and a management server 107 via a router-integrated ONU 105. Note that ONU is an abbreviated form of Optical Network Unit. For example, the host terminal 101 downloads an extension application, described hereinafter, from the management server 107 via the router-integrated ONU 105.

The image forming apparatus 100 performs a print operation using consumables. Note that as the printing method used by the image forming apparatus 100, an electrophotographic method, an inkjet method, or a stencil printing method can be used, or any other suitable method can be used. The router-integrated ONU 105 is an optical line terminal device and has a function of converting an optical signal of the optical line and an electrical digital signal to each other. In the present embodiment, the router-integrated ONU 105 is connected to the Internet 106 via the optical line.

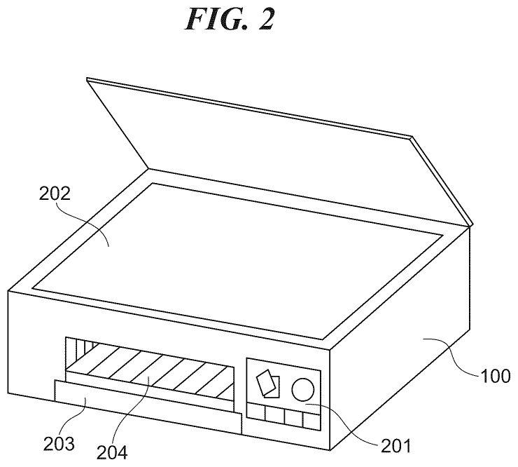

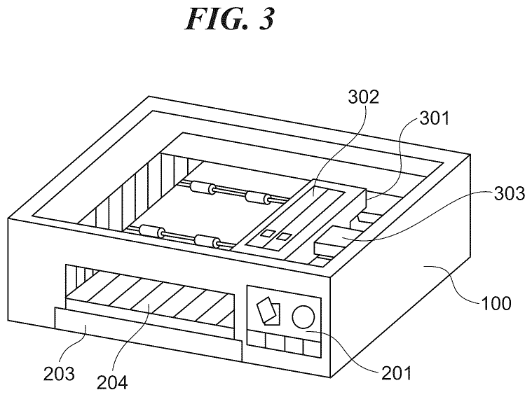

FIG. 2 is a schematic view showing an example of the image forming apparatus 100 appearing in FIG. 1. FIG. 3 is a schematic view showing an example of an internal structure of the image forming apparatus 100 appearing in FIG. 1.

As shown in FIG. 2, the image forming apparatus 100 includes a touch panel 201, an original platen glass 202, a sheet feeding port 203, and a print result discharge port 204. Further, as shown in FIG. 3, the image forming apparatus 100 includes a carriage 301, ink tanks 302, and a packaging material 303, arranged therein.

The user can control the image forming apparatus 100 by operating the touch panel 201. Note that the touch panel 201 is an example of operation means of the image forming apparatus 100, and insofar as it is a component which can receive an instruction from a user, the size, method, and the like thereof are not limited to those of the touch panel 201.

In the image forming apparatus 100, scanning of a sheet placed on the original platen glass 202 is performed. A scanned image obtained by scanning a sheet is stored in the image forming apparatus 100 and is further transmitted to the management server 107. As a protocol used when transmitting e.g. a scanned image, for example, HTTP, HTTPS, SMTP, SMTPS, FTP, or FTPS can be used. For example, in a case where SMTP or SMTPS is used, a scanned image is transmitted to the management server 107 in a state attached to an electronic mail.

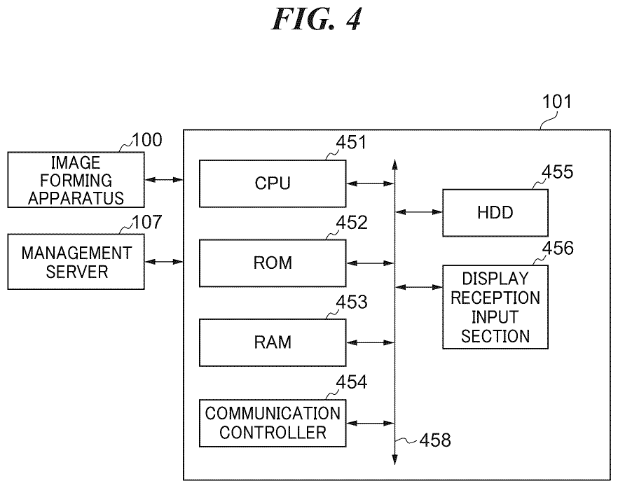

FIG. 4 is a block diagram schematically showing a hardware configuration of the host terminal 101 appearing in FIG. 1. The host terminal 101 is a communication apparatus which is connected to a network via the Internet 106 and can communicate with the management server 107 and the image forming apparatus 100. Note that in the present embodiment, as the host terminal 101, a PC, a smartphone, a tablet terminal, or the like is assumed, and the following description will be given of the configuration of the host terminal 101 by taking a PC as an example.

Referring to FIG. 4, the host terminal 101 includes a central processing unit (CPU) 451, a read only memory (ROM) 452, a random access memory (RAM) 453, a communication controller 454, a hard disk drive (HDD) 455, and a display reception input section 456. These are interconnected via a bus 458.

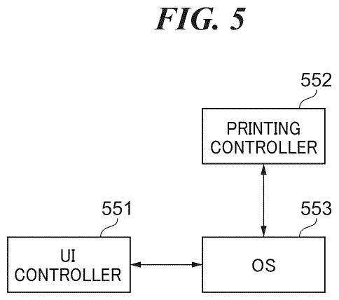

The CPU 451 controls the overall operation of the host terminal 101. The ROM 452 stores a variety of programs. For example, the ROM 452 stores an OS 553 appearing in FIG. 5, a printer driver provided by the maker of the image forming apparatus 100, and so forth. The printer driver is configured according to the specifications defined by the OS 553 and operates when called by the OS 553.

The RAM 453 is used as a work area for the CPU 451, and further as an area for temporarily storing a variety of data. The communication controller 454 controls transmission and reception of data to and from an external apparatus via the Internet 106 and a variety of interfaces. The HDD 455 is a nonvolatile memory and holds a variety of data necessary for maintenance of the host terminal 101. The display reception input section 456 receives e.g. an instruction from a user and further, displays a variety of information.

FIG. 5 is a block diagram schematically showing a software configuration of the host terminal 101 appearing in FIG. 1. As shown in FIG. 5, the host terminal 101 includes, as the software, a UI controller 551, a printing controller 552, and the OS 553. These are mainly stored in the ROM 452 or the HDD 455, and processing operations of these are realized by the CPU 451 loading programs for operating these into the RAM 453 and executing the loaded programs.

The UI controller 551 provides information to a user of the host terminal 101 via the display reception input section 456. Further, the UI controller 551 receives an instruction provided by a user of the host terminal 101. The printing controller 552 provides an instruction for causing the image forming apparatus 100 to print data generated by a variety of application programs and the like.

The OS 553 is stored in the ROM 452 and controls the overall operation of the host terminal 101. The OS 553 controls exchange of information between the pieces of software of the host terminal 101 and controls execution of each piece of software. Note that in the present embodiment, the description will be given assuming that the host terminal 101 has installed the Windows OS provided by Microsoft (registered trademark) as the OS 553, by way of example. The OS 553 includes general-purpose print software, such as an IPP class driver. The general-purpose print software is a general-purpose program that can be commonly used for image forming apparatuses of a plurality of makers, and generates and outputs an instruction which can be interpreted by the image forming apparatuses of the plurality of makers.

Further, the OS 553 has the WPP as a mode for enhancing security related to printing. By enabling the WPP, for example, it is made impossible for an attacker to deceive a spooler by using a symbolic link into reading a malicious code. Further, in a case where it is possible to shift a general task which is executed by a spooler process to a process executed by the user authority, and these processes have a memory corruption vulnerability, it is possible to limit the adverse influence of the memory corruption vulnerability to actions which can be executed only by a user. When the WPP is enabled, the host terminal 101 becomes incapable of using the printer driver, and hence instructs the image forming apparatus 100 connected to the host terminal 101 to execute print processing by using the general-purpose print software included in the OS 553 in advance.

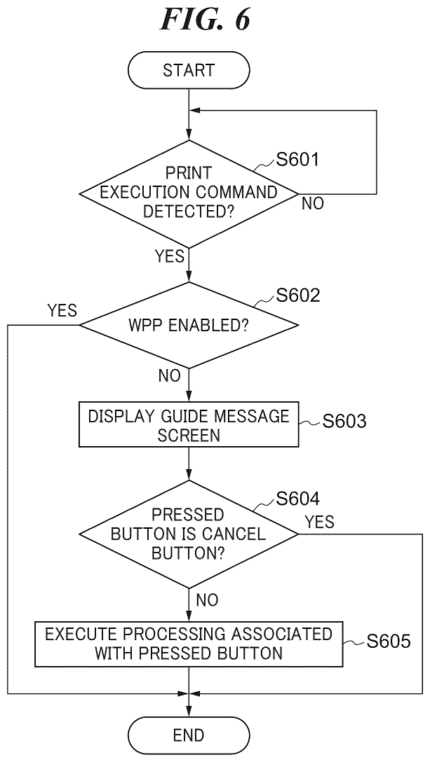

FIG. 6 is a flowchart of a control process performed by the host terminal 101 appearing in FIG. 1. Note that the control process in FIG. 6 is realized by the CPU 451 executing a program stored e.g. in the ROM 452 for operating the OS 553.

Referring to FIG. 6, first, in a step S601, the OS 553 determines whether or not a print execution command from the printer driver has been detected. Note that the print execution command includes print job data itself. If it is determined that a print execution command from the printer driver has not been detected, the present process remains in the step S601. If it is determined that a print execution command from the printer driver has been detected, the present process proceeds to a step S602. Note that if it is determined that a print execution command from the printer driver has been detected, the OS 553 analyzes information of the number of pages to be printed, the number of copies, an area to be printed, and so forth in the current print processing from the detected print execution command to thereby acquire information on these.

In the step S602, the OS 553 determines whether or not the WPP has been enabled. If it is determined that the WPP has been enabled, the present process is terminated. If it is determined that the WPP is has not been enabled, the present process proceeds to a step S603.

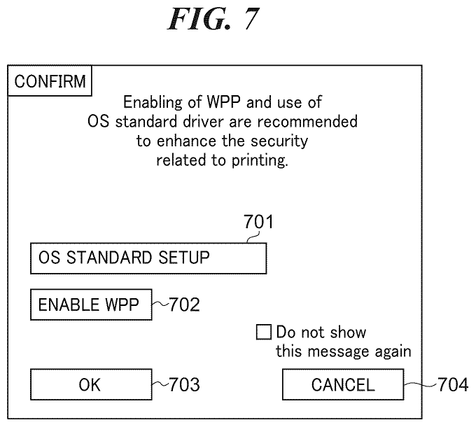

In the step S603, the OS 553 displays a guide message screen shown in FIG. 7 on the display reception input section 456. The guide message screen includes a guide message for prompting the user to enable the WPP. Further, the guide message screen includes an OS standard setup button 701, a WPP enabling button 702, an OK button 703, and a cancel button 704.

The OS standard setup button 701 is for instructing execution of setup processing for associating the general-purpose print software with the image forming apparatus 100. When this setup processing is completed, the host terminal 101 is enabled to generate print job data by using the general-purpose print software and transmit the print job data to the image forming apparatus 100.

The WPP enabling button 702 is for instructing enabling of the WPP. The OK button 703 is for instructing the start of processing for transmitting print job data associated with the print execution command detected in the step S601 to the image forming apparatus 100. The cancel button 704 is for instructing the cancellation of the processing for transmitting print job data associated with the print execution command detected in the step S601 to the image forming apparatus 100.

When it is detected that the user has pressed one of the buttons on the guide message screen, the OS 553 determines in a step S604 whether or not the pressed button is the cancel button 704. If it is determined that the pressed button is the cancel button 704, the present process is terminated.

If it is determined that the pressed button is not the cancel button 704, the present process proceeds to a step S605. In the step S605, the OS 553 executes processing associated with the pressed button.

For example, in a case where the pressed button is the OS standard setup button 701, the above-described setup processing is executed. Further, in a case where the pressed button is the WPP enabling button 702, the processing for enabling the WPP is executed. Further, in a case where the pressed button is the OK button 703, the print job data transmission processing is executed after the setup processing and the WPP enabling processing are executed. In the print job data transmission processing, print job data is generated by the general-purpose print software, and the generated print job data is transmitted to the image forming apparatus 100. When the processing in the step S605 is completed, the present process is terminated.

According to the above-described embodiment, in a case where it is determined that the WPP has not been enabled, the guide message for prompting a user to enable the WPP is displayed on the display reception input section 456. With this, it is possible to prevent a user from forgetting to set the WPP.

Further, in the above-described embodiment, the WPP enabling button 702 is displayed together with the guide message. With this, the user having confirmed the guide message can provide an instruction for enabling the WPP without performing an operation of switching the screen.

Further, in the above-described embodiment, the OS standard setup button 701 is displayed together with the guide message and the WPP enabling button 702. With this, the user having confirmed the guide message can provide not only an instruction for enabling the WPP, but also an instruction for executing the processing for setting up the general-purpose print software without performing an operation of switching the screen. Further, since the guide message screen has the WPP enabling button 702 and the OS standard setup button 701, the user can easily recognize what kind of change is made with respect to the functions associated with these buttons.

Note that in the above-described embodiment, in place of the OS standard setup button 701 and the WPP enabling button 702, messages indicating the functions of these buttons can be displayed on the guide message screen. With this configuration, the user is only required to select one of the OK button 703 and the cancel button 704 with respect to the operation on the guide message screen, and hence the user operation becomes more understandable.

Further, in the above-described embodiment, if it is determined in the step S601 that a print execution command from the printer driver has been detected, it can be determined based on this determination result that the WPP has not been enabled, and the determination in the step S602 can be skipped.

Further, in the above-described embodiment, control to reduce the frequency of displaying the guide message on the display reception input section 456 can be performed.

Here, as described above, when the WPP is enabled, the host terminal 101 becomes incapable of using the printer driver, and hence instructs the image forming apparatus 100 to execute print processing by using the general-purpose print software in place of the printer driver. On the other hand, the general-purpose print software has available functions more limited than those of the printer driver and supports only settings of general print functions (e.g. settings of a sheet type and a printing direction) out of a plurality of print functions which can be used in the image forming apparatus 100. That is, the general-purpose print software cannot allow a user to perform setting of a print function specific to the maker, which can be used in the image forming apparatus 100. There are a certain number of users who use the host terminal 101 by disabling the WPP, so as to make it possible to instruct execution of print processing by using the printer driver which can use not only the settings of the general print functions, but also the setting of the print function specific to the maker. For the user who intentionally disables the WPP as mentioned above, if the guide message is displayed on the display reception input section 456 whenever execution of print processing is instructed from the host terminal 101 to the image forming apparatus 100, the user feels annoyed.

To prevent this, in the present embodiment, in a case where it is determined that the WPP has not been enabled, and at the same time, the total number of times of printing instructed to the image forming apparatus 100 is equal to or larger than a first threshold value, the guide message is displayed on the display reception input section 456.

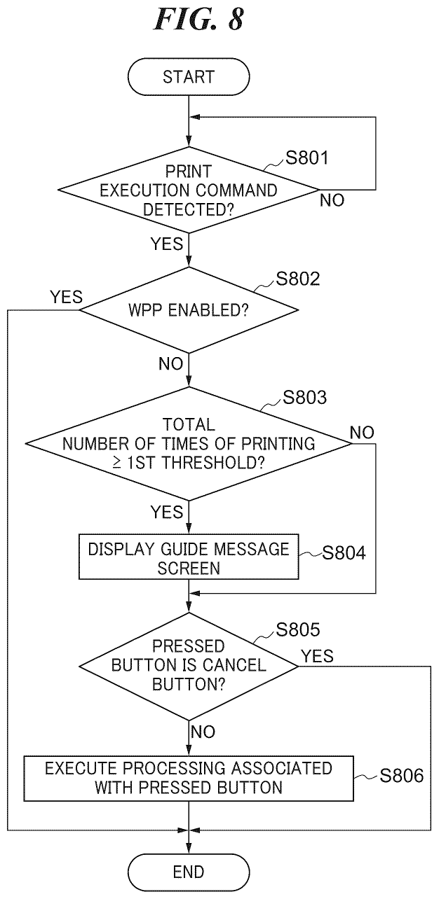

FIG. 8 is a flowchart showing a variation of the control process performed by the host terminal 101 appearing in FIG. 1. Note that the control process in FIG. 8 is similar to the above-described control process in FIG. 6, and the following description will be given mainly of different points from the above-described control process in FIG. 6. Similar to the control process in FIG. 6, the control process in FIG. 8 is also realized by the CPU 451 executing a program stored e.g. in the ROM 452, for operating the OS 553. Note that in the present embodiment, the host terminal 101 holds the total number of times of printing, indicating the total number of times of print processing executed according to the execution instruction provided from the host terminal 101 to the image forming apparatus 100.

Referring to the FIG. 8, steps S801 and S802 which are the same as the steps S601 and S602 are executed. If it is determined that the WPP has been enabled, the present process is terminated. If it is determined that the WPP has not been enabled, the present process proceeds to a step S803.

In the step S803, the OS 553 determines whether or not the total number of times of printing is equal to or larger than the first threshold value. Note that the first threshold value can be a value set by the user or a fixed value determined in advance. Note that in a configuration in which the first threshold value can be set by the user, the user can change the first threshold value at a desired timing.

If it is determined that the total number of times of printing is smaller than the first threshold value, the present process proceeds to a step S805 which is the same processing as the step S604. If it is determined that the total number of times of printing is equal to or larger than the first threshold value, the present process proceeds to a step S804 which is the same processing as the step S603, wherein the guide message screen is displayed on the display reception input section 456. For example, in a case where the first threshold value is 0, if the WPP has not been enabled and at the same time a print execution command is detected for the first time, the guide message screen is displayed on the display reception input section 456. Further, in a case where the first threshold value is 10, even when the WPP has not been enabled, the guide message screen is not displayed on the display reception input section 456 until the total number of times of printing reaches 10.

When the step S804 is completed, the present process proceeds to the step S805. If it is determined that the pressed button is the cancel button 704, the present process is terminated. If it is determined that the pressed button is not the cancel button 704, the present process proceeds to a step S806. In the step S806, the OS 553 executes processing associated with the pressed button. Note that in a case where the pressed button is the OS standard setup button 701 or the WPP enabling button 702, the same processing as the processing described in the step S605 is executed. Further, in a case where the pressed button is the OK button 703, the print job data transmission processing is executed after the setup processing and the processing for enabling the WPP are executed, and further, processing for incrementing the total number of times of printing is executed. After that, the present process is terminated.

In the above-described embodiment, in a case where it is determined that the WPP has not been enabled, and at the same time, the total number of times of printing, indicating the total number of times of print processing executed according to the execution instruction provided from the host terminal 101 to the image forming apparatus 100, is equal to or larger than the first threshold value, the guide message is displayed on the display reception input section 456. This makes it possible to reduce the frequency of displaying the guide message on the display reception input section 456, and as a result, it is possible to reduce the annoyance felt by a user who uses the host terminal 101 by intentionally disabling the WPP.

Note that although in the above-described embodiment, the description has been given of the configuration that uses the total number of times of printing for the control to reduce the frequency of displaying the guide message on the display reception input section 456, this is not limitative. For example, a total printed area based on print processing executed according to execution instructions provided to the image forming apparatus 100 can be used. For example, the host terminal 101 holds the total printed area and determines in the step S803 whether or not the total printed area is equal to or larger than a second threshold value. If it is determined that the total printed area is equal to or larger than the second threshold value, the control process in FIG. 8 proceeds to the step S804, whereas if it is determined that the total printed area is smaller than the second threshold value, the control process in FIG. 8 proceeds to the step S805. Further, in a case where the pressed button is the OK button 703, in the step S806, not the processing for incrementing the total number of times of printing, but processing for adding the printed area identified based on the transmitted print job data to the total printed area held in advance, is executed. By performing this control, it is also possible to reduce the frequency of displaying the guide message on the display reception input section 456.

Further, the total number of printed pages based on the print processing executed according to the execution instruction provided to the image processing apparatus 100 can be used for the control to reduce the frequency of displaying the guide message on the display reception input section 456. For example, the host terminal 101 holds the total number of printed pages and determines whether or not the total number of printed pages is equal to or larger than a third threshold value in the step S803. If it is determined that the total number of printed pages is equal to or larger than the third threshold value, the control process in FIG. 8 proceeds to the step S804, whereas if it is determined that the total number of printed pages is smaller than the third threshold value, the control process in FIG. 8 proceeds to the step S805. Further, in a case where the pressed button is the OK button 703, in the step S806, not the processing for incrementing the total number of times of printing, but processing for adding the number of printed pages identified based on the transmitted print job data to the total number of printed pages held in advance, is executed. By performing this control, it is also possible to reduce the frequency of displaying the guide message on the display reception input section 456.

Further, the total number of printed copies based on the print processing executed according to the execution instruction provided to the image processing apparatus 100 can be used for the control to reduce the frequency of displaying the guide message on the display reception input section 456. For example, the host terminal 101 holds the total number of printed copies and determines whether or not the total number of printed copies is equal to or larger than a fourth threshold value in the step S803. If it is determined that the total number of printed copies is equal to or larger than the fourth threshold value, the control process in FIG. 8 proceeds to the step S804, whereas if it is determined that the total number of printed copies is smaller than the fourth threshold value, the control process in FIG. 8 proceeds to the step S805. Further, in a case where the pressed button is the OK button 703, in the step S806, not the processing for incrementing the total number of times of printing, but processing for adding the number of printed copies identified based on the transmitted print job data to the total number of printed copies held in advance, is executed. By performing this control, it is also possible to reduce the frequency of displaying the guide message on the display reception input section 456. Note that, similar to the above-described first threshold value, all of the second, third, and fourth threshold values can be values set by the user, or predetermined fixed values. Further, in a configuration in which these threshold values can be set by the user, the user can change these threshold values at a desired timing.

Further, a time period during which the WPP has not been enabled (hereinafter referred to as the WPP disabled period) can be used for the control to reduce the frequency of displaying the guide message on the display reception input section 456. For example, the host terminal 101 holds the WPP disabled period and determines in the step S803 whether or not the WPP disabled period is equal to or longer than a predetermined time period. If it is determined that the WPP disabled period is equal to or longer than the predetermined time period, the control process in FIG. 8 proceeds to the step S804, whereas if it is determined that the WPP disabled period is shorter than the predetermined time period, the control process in FIG. 8 proceeds to the step S805. Further, in a case where the pressed button is the OK button 703, in the step S806, not the processing for incrementing the total number of times of printing, but processing for updating the WPP disabled period held in advance, is executed. By performing this control as well, it is also possible to reduce the frequency of displaying the guide message on the display reception input section 456.

Note that although in the above-described embodiment, the description has been given of the configuration in which the OS 553 executes the control processes in FIGS. 6 and 8, this configuration is not limitative. For example, the printer driver installed in the host terminal 101 can execute the control processes in FIGS. 6 and 8. In this configuration, it is also possible to obtain the same advantageous effects as provided by the above-described embodiment.

Further, in the above-described embodiment, the guide message screen can be configured such that an instruction can be provided therefrom for executing the processing for setting up the general-purpose print software and the extension application. The extension application is software supporting the general-purpose print software and is e.g. a Print Support Application (PSA) provided by the maker of the image forming apparatus 100. As described above, the general-purpose print software supports only the settings of the general print functions (e.g. the settings of a sheet type and printing direction) out of the plurality of print functions which can be used in the image forming apparatus 100. On the other hand, by using the extension application, the user is enabled to perform not only the setting of the above-described general print functions, but also the setting of the print function specific to the maker, which can be used in the image forming apparatus 100. Note that the extension application is software which is not included in the OS 553 in advance, and hence the user is required to operate the host terminal 101 to download the extension application from the management server 107 via the Internet 106 and install the downloaded extension application. Alternatively, the extension application can be automatically installed based on connection of the image forming apparatus 100 to the host terminal 101.

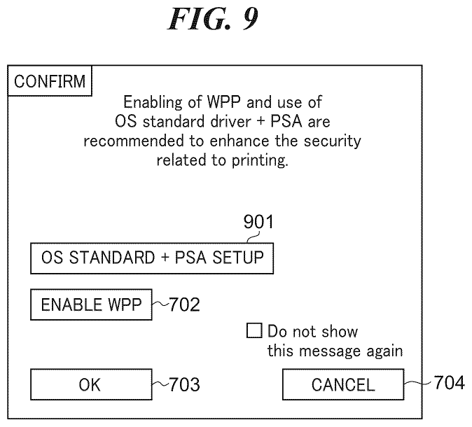

FIG. 9 is a diagram showing another example of the guide message screen displayed on the display reception input section 456 appearing in FIG. 4. Similar to the above-described guide message screen shown in FIG. 7, the guide message screen shown in FIG. 9 is displayed on the display reception input section 456 by the OS 553 or by the printer driver. Further, different from the guide message screen shown in FIG. 7, the guide message screen shown in FIG. 9 includes an OS standard+PSA setup button 901.

The OS standard+PSA setup button 901 is for instructing execution of the setup processing for associating the general-purpose print software and the extension application with the image forming apparatus 100. When the OS standard+PSA setup button 901 is selected, the OS 553 displays a screen for installing the extension application on the display reception input screen 456. With this, it is possible to install the extension application necessary for performing the setting of the print function specific to the maker of the image forming apparatus 100 into the host terminal 101. Note that when the OS standard+PSA setup button 901 is selected, the extension application can be automatically installed without displaying the screen for installing the extension application on the display reception input screen 456.

When the above-described setup processing is completed, the host terminal 101 is enabled to generate print job data by using the general-purpose print software and the extension application and transmit the generated print job data to the image forming apparatus 100. With this configuration, the user can use not only the general functions of the image forming apparatus 100, supported by the general-purpose print software, but also a function supported by the extension application, which is specific to the maker of the image forming apparatus 100. According to the present disclosure, it is possible to prevent a user from forgetting to set a mode for enhancing the security related to printing.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-119508 filed Jul. 25, 2024, which is hereby incorporated by reference herein in its entirety.

What is claimed is:

1. A non-transitory computer-readable storage medium storing one or more programs installed in an information processing apparatus that includes an OS having a mode for enhancing security related to printing,
wherein the one or more programs include instructions, which when executed by one or more processors of the information processing apparatus, cause the information processing apparatus to:
determine whether or not the mode has been enabled; and
display, in a case where it is not determined that the mode has not been enabled, a message for prompting a user to enable the mode on a display section of the information processing apparatus.

2. The storage medium according to claim 1, wherein the one or more programs include a program for operating the OS.

3. The storage medium according to claim 1, wherein the one or more programs include a program for operating a printer driver provided by a maker of an image forming apparatus connected to the information processing apparatus.

4. The storage medium according to claim 1, wherein the instructions, when executed by the one or more processors, cause the information processing apparatus to display an instruction object for providing an instruction for enabling the mode on the display section of the information processing apparatus, together with the message.

5. The storage medium according to claim 4, wherein the instructions, when executed by the one or more processors, cause the information processing apparatus to display, not only the message and the instruction object, but also another instruction object for instructing execution of processing for setting up a general-purpose program which is included in the OS in advance and can be commonly used for printers of a plurality of makers, on the display section of the information processing apparatus.

6. The storage medium according to claim 4, wherein the instructions, when executed by the one or more processors, cause the information processing apparatus to display, when another instruction object for instructing execution of processing for setting up both of the general-purpose program which is included in the OS in advance and can be commonly used for printers of a plurality of makers and a program supporting the general-purpose program is displayed on the display section of the information processing apparatus, and in response to selection of the other instruction object, a screen for installing the program supporting the general-purpose program is displayed.

7. The storage medium according to claim 1, wherein the instructions, when executed by the one or more processors, cause the information processing apparatus to display the message on the display section of the information processing apparatus, in a case where it is not determined that the mode has been enabled and, at the same time, a total number of times of printing, which indicates the total number of times of print processing executed according to respective execution instructions provided from the information processing apparatus to an image forming apparatus connected to the information processing apparatus, is equal to or larger than a first threshold value.

8. The storage medium according to claim 1, wherein the instructions, when executed by the one or more processors, cause the information processing apparatus to display the message on the display section of the information processing apparatus, in a case where it is not determined that the mode has been enabled, and at the same time a total printed area based on print processing executed according to execution instructions provided from the information processing apparatus to an image forming apparatus connected to the information processing apparatus is equal to or larger than a second threshold value.

9. The storage medium according to claim 1, wherein the instructions, when executed by the one or more processors, cause the information processing apparatus to display the message on the display section of the information processing apparatus, in a case where it is not determined that the mode has been enabled, and at the same time a total number of printed pages based on print processing executed according to execution instructions provided from the information processing apparatus to an image forming apparatus connected to the information processing apparatus is equal to or larger than a third threshold value.

10. The storage medium according to claim 1, wherein the instructions, when executed by the one or more processors, cause the information processing apparatus to display the message on the display section of the information processing apparatus in a case where it is not determined that the mode has been enabled, and at the same time a total number of printed copies based on print processing executed according to an execution instruction provided from the information processing apparatus to an image forming apparatus connected to the information processing apparatus is equal to or larger than a fourth threshold value.

11. The storage medium according to claim 1, wherein the instructions, when executed by the one or more processors, cause the information processing apparatus to display the message on the display section of the information processing apparatus, in a case where it is not determined that the mode has been enabled, and at the same time a time period during which the mode has not been enabled is equal to or longer than a predetermined time period.

12. A method of controlling an information processing apparatus including an OS having a mode for enhancing security related to printing, the method comprising:
determining whether or not the mode has been enabled; and
displaying, in a case where it is not determined that the mode has been enabled, a message for prompting a user to enable the mode on a display section of the information processing apparatus.

13. An information processing apparatus including an OS having a mode for enhancing security related to printing, the information processing apparatus comprising:
one or more processors; and
at least one memory storing executable instructions, which when executed by the one or more processors, cause the information processing apparatus to:
determine whether or not the mode has been enabled; and
display, in a case where it is not determined that the mode has been enabled, a message for prompting a user to enable the mode on a display section of the information processing apparatus.
